(19) United States
(12) Patent Application Publication
(10) Pub. No.: US 2016/0023393 A1
(43) Pub. Date: Jan. 28, 2016

(54) METHOD OF MAKING POLYMERIC MULTILAYER FILMS

(71) Applicant: 3M INNOVATIVE PROPERTIES COMPANY, Saint Paul, MN (US)

(72) Inventors: David F. Slama, City of Grant, MN (US); Garth V. Antila, Hudson, WI (US); Steven J. Flanagan, Lake Elmo, MN (US); Brent R. Hansen, New Richmond, WI (US); Thomas P. Hanschen, Mendota Heights, MN (US)

(73) Assignee: 3M INNOVATIVE PROPERTIES COMPANY, Saint Paul, MN (US)

(21) Appl. No.: 14/772,878

(22) PCT Filed: Mar. 4, 2014
(86) PCT No.: PCT/US2014/020281

§ 371 Date: Sep. 4, 2015

Related U.S. Application Data
(60) Provisional application No. 61/777,535, filed on Mar. 12, 2013.

(51) Int. Cl. B29C 47/00; B29C 47/34; B29C 47/88; B29C 47/06

(52) U.S. Cl. CPC B29C 47/0061; B29C 47/0019; B29C 47/0066; B29C 47/065; B29C 47/34; B29C 47/8805; B29K 2023/0633

(57) ABSTRACT

Method of making at least two distinct, separate polymeric films. Embodiments of polymeric multilayer film described herein are useful, for example, for filtration or acoustic absorption.

### CROSS REFERENCE TO RELATED APPLICATION

This application claims the benefit of U.S. Provisional Patent Application No. 61/777,535, filed Mar. 12, 2013, the disclosure of which is incorporated by reference herein in its entirety.

### BACKGROUND

Perforated films are typically used in the personal hygiene field providing a fluid transfer film allowing the fluid to be removed from areas near to the skin and into the absorbent area. Other common applications are in the food packaging industry and more recently acoustics absorption. Perforated films for these applications are usually less than 100 micrometers (0.004 inch) thick (more typically less than 50 micrometers (0.002 inch) thick) and are made, for example, of olefins, polypropylene,6 or polyethylene.

Typical processing methods to produce perforated films include; vacuum drawing of film into a perforated panel or roll, use of pressurized fluid to form and puncture the film, needle punching with either cold or hot needles, or lasers to melt holes in the film. These processes, however, tend to have processing limitations such a hole size, hole density, and/or film thickness of film.

Vacuum or pressurized fluid forming of perforated films tends to be limited to relatively thin films (i.e., films less than 100 micrometers thick) due to the forces available to deform and puncture the film. Also materials used in this type of forming process tend to be limited to olefin-based polymers. Another characteristic of this type of process is the creation of a protrusion in the film where the film is stretched until a perforation is created. This protrusion can be an advantage in the case of fluid control where the protrusion can act as a directional flow control feature. However, it can also be a disadvantage in applications where a low pressure drop is desired. The protrusion creates an elongated hole thereby increasing the surface area and increase fluid drag.

Needle punching processes are also largely used for relatively thin films, but film thicknesses up to about 254 micrometers (0.010 inch) are sometimes seen. Limitations with this process tend to include perforation diameter holes per unit area, and protrusions in the film.

Laser perforation processes can provide relatively small holes (i.e., less than 50 micrometers), can perforate a wide range of thicknesses, can create perforations that are planar with the film surfaces (i.e., without the protrusions associated, for example, with needle punching processes). Limitations of laser perforation processes include the types of materials that suitable for the process, and processing speeds and costs. Laser perforation processes tend to be best suited for processing films from polyethylene terephthalate (PET), polycarbonate (PC), or other higher glass transition temperature materials. Lasers are often not very effective, for example, in perforating olefin-based materials.

### SUMMARY

In one aspect, the present disclosure describes a method of making at least two distinct, separate polymeric films, the method comprising:
extruding at least two (in some embodiments, at least three, four, five, or more) polymeric layers into a nip to provide a polymeric multilayer film, wherein the nip comprises a first roll having a structured surface that imparts indentations through a first major planar (i.e., the relatively flat surface major surface excluding the indentations) surface of the polymeric multilayer film;
passing the first major planar surface having the indentations over a chill roll while applying a heat source to a generally opposed second major surface of the polymeric multilayer film, wherein the application of heat from the heat source results in formation of an array of openings extending between the first and second major surfaces of the polymeric multilayer film; and
separating at least the first and second layers of the polymeric multilayer film having the array of openings to provide at least two distinct, separate polymeric films.

Embodiments of polymeric multilayer film described herein are useful, for example, for filtration and acoustic absorption.

### BRIEF DESCRIPTION OF THE DRAWINGS

FIG. 1, 1A, 1B, and 1C are schematics of an exemplary method for making exemplary polymeric films.

FIG. 2, 2A, 2B, 2C, and 2D are schematics of another exemplary method for making exemplary polymeric films.

### DETAILED DESCRIPTION

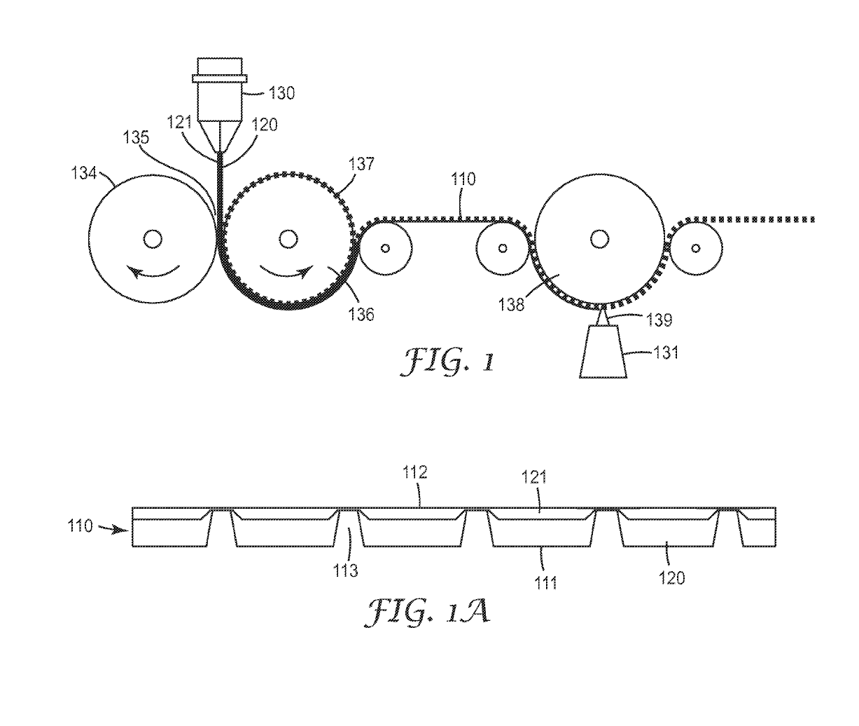

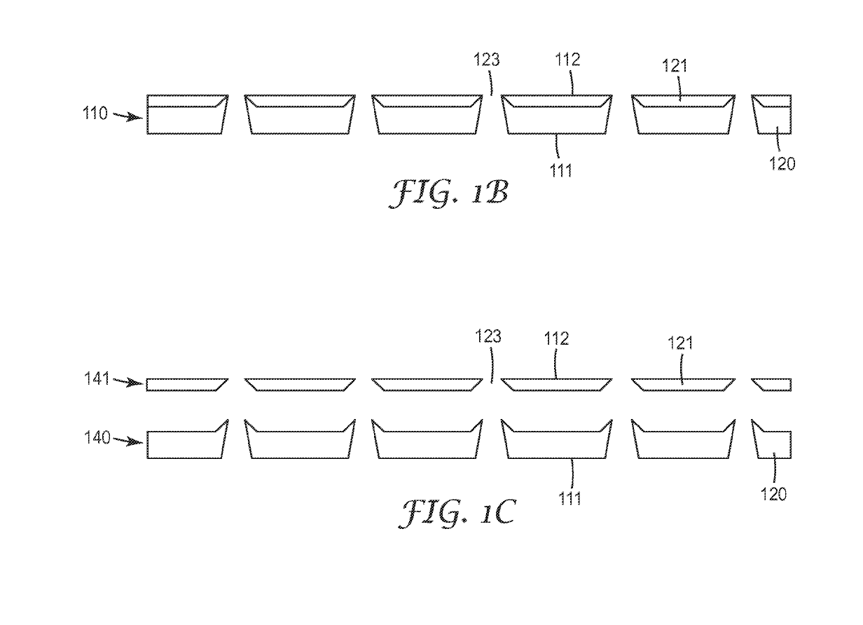

Referring to FIG. 1, a schematic of an exemplary method for making at least two distinct, separate polymeric films 140, 141 is shown. At least two polymeric layers 120, 121 are extruded into nip 135 to provide polymeric multilayer film 110. Nip 135 comprises first roll 136 having structured surface 137 that imparts indentations 113 through first major planar surface 111 of polymeric multilayer film 110. First major planar surface 111 having indentations 113 is passed over chill roll 138 while applying 139 heat source to generally opposed second major surface 112 of polymeric multilayer film 110. Application of heat from heat source 139 results in formation of an array of openings 123 extending between first and second major surfaces 111, 112 of polymeric multilayer film 110. At least first and second layers 120, 121 of polymeric multilayer film 110 having array of openings 123 to provide at least two distinct, separate polymeric films 140, 141.

Suitable extrusion apparatuses (including materials for making components of the apparatuses) for making multilayer films described herein should be apparent to those skilled in the art after reviewing the instant disclosure, including the working examples. For examples, the rolls (e.g., 134, 136, 138, 234, 236, 238) can made of metals such as steel. In some embodiments the surface of rolls contacting the polymeric material(s) are chrome plated, nickel plated, copper plated, or aluminum. Rolls can be chilled, for example using conventional techniques such as water cooling. Nip force can be provided, for example, by pneumatic cylinders.

Exemplary extrusion speeds include 3-15 m/min. (in some embodiments, in a range from 15-50 m/min, 50-100 m/min , or more). Exemplary extrusion temperatures are in range from 200° C.-230° C. (in some embodiments, in a range from 230° C.-260° C., 260-300° C., or greater).

Multilayer polymeric films typically comprise polyolefin, polyethylene, and polypropylene.

Exemplary polymeric materials for making the polymeric multilayer films include polyamide 6, polyamide 66, polyethyleneterephthalate (PET), copolyesters (PETg), cellulose acetobutyrate (CAB), polymethylmethacrylate (PMMA), acrylonitrile butadiene styrene (ABS), polybutyleneterephthalate (PBT), polyethylenenaphthalate (PEN), polyolefin, polyethylene, and polystyrene (PS), ethylene vinyl alcohol (EVOH), polycarbonate (PC), and polypropylene. Suitable polypropylene materials include homo polypropylene and modified polypropylene such as block copolymers, impact copolymer, and random copolymers.

Optionally, any of the polymeric materials comprising an article described herein may comprise additives such as inorganic fillers, pigments, slip agents, and flame retardants.

In some embodiments of polymeric multilayer films described herein have a thickness greater than 125 micrometers, 150 micrometers, 200 micrometers, 250 micrometers, 500 micrometers, 750 micrometers, 1000 micrometers, 1500 micrometers, 2000 micrometers, or even at least 2500 micrometers; in some embodiments, in a range from 125 micrometers to 1500 micrometers, or even 125 micrometers to 2500 micrometers.

The openings may be in any of a variety of shapes, including circles and ovals.

In some embodiments of polymeric multilayer films described herein have at least 30 openings/cm² (in some embodiments, at least 100 openings/cm², 200 openings/cm², 250 openings/cm², 300 openings/cm², 400 openings/cm², 500 openings/cm², 600 openings/cm², 700 openings/cm², 750 openings/cm², 800 openings/cm², 900 openings/cm², 1000 openings/cm², 2000 openings/cm², 3000 openings/cm², or even least 4000 openings/cm²; in some embodiments, in a range from 30 openings/cm² to 200 openings/cm², 200 openings/cm² to 500 openings/cm², or even 500 openings/cm² to 4000 openings/cm²).

Embodiments of polymeric multilayer film described herein are useful, for example, for filtration and acoustic absorption.

### EXEMPLARY EMBODIMENTS

1. A method of making at least two distinct, separate polymeric films, the method comprising:
extruding at least two polymeric layers into a nip to provide a polymeric multilayer film, wherein the nip comprises a first roll having a structured surface that imparts indentations through a first major planar surface of the polymeric multilayer film; and
passing the first major planar surface having the indentations over a chill roll while applying a heat source to a generally opposed second major surface of the polymeric multilayer film, wherein the application of heat from the heat source results in formation of an array of openings extending between the first and second major surfaces of the polymeric multilayer film;
separating at least the first and second layers of the polymeric multilayer film having the array of openings to provide at least two distinct, separate polymeric films.

2. The method of Exemplary Embodiment 1, wherein the first layer has a thickness not greater than 125 micrometers (in some embodiments, not greater than 100 micrometers, 75, or even not greater than 50 micrometers; in some embodiments, in a range from 25 micrometers to 125 micrometers, 25 micrometers to 100 micrometers, or even 25 micrometers to 75 micrometers).

3. The method of either Exemplary Embodiment 1 or 2, wherein the second layer has a thickness not greater than 125 micrometers (in some embodiments, not greater than 100 micrometers, 75, or even not greater than 50 micrometers; in some embodiments, in a range from 25 micrometers to 125 micrometers, 25 micrometers to 100 micrometers, or even 25 micrometers to 75 micrometers).

4. The method of any preceding Exemplary Embodiment having at least 30 openings/cm² (in some embodiments, at least 100 openings/cm², 200 openings/cm², 250 openings/cm², 300 openings/cm², 400 openings/cm², 500 openings/cm², 600 openings/cm², 700 openings/cm², 750 openings/cm², 800 openings/cm², 900 openings/cm², 1000 openings/cm², 2000 openings/cm², 3000 openings/cm², or even least 4000 openings/cm²; in some embodiments, in a range from 30 openings/cm² to 200 openings/cm², 200 openings/cm² to 500 openings/cm², or even 500 openings/cm² to 4000 openings/cm²).

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLE 1

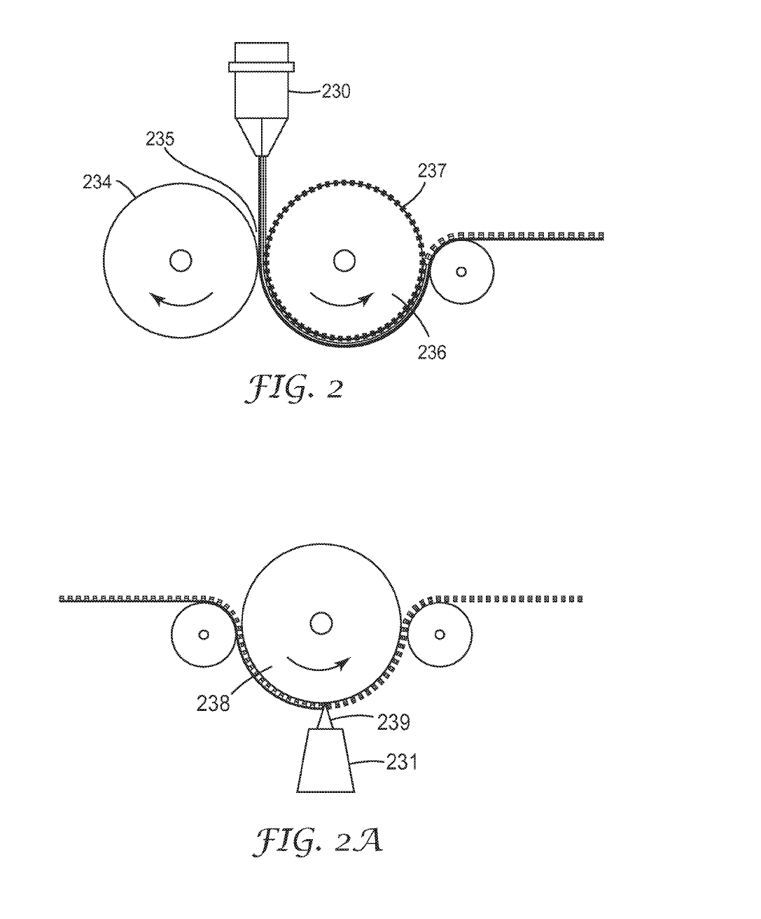

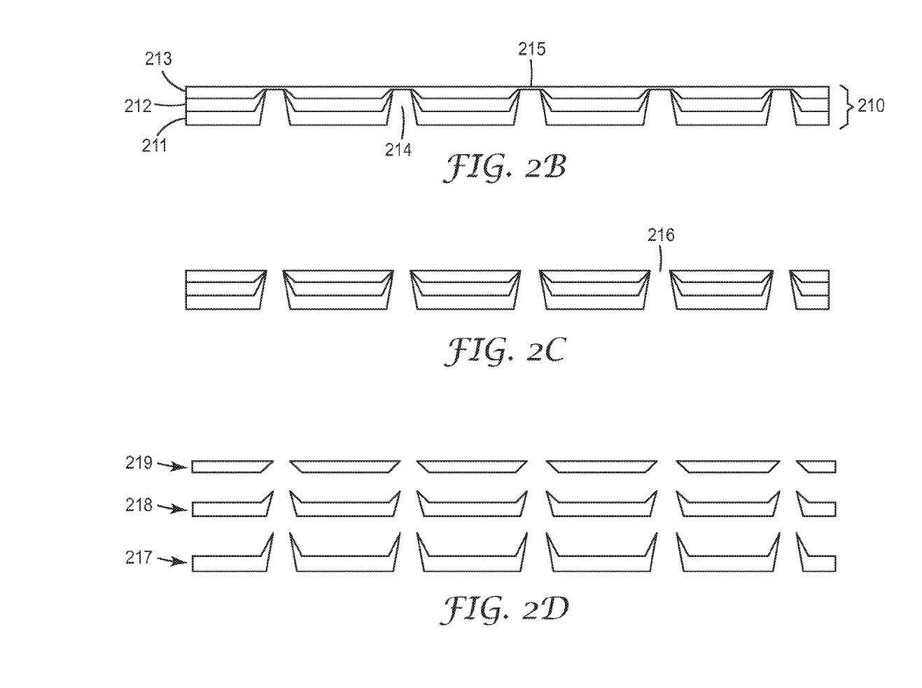

A perforated multilayer polymeric film was prepared using the following procedures. A three layer polymeric film (ABC) consisting of layers A, B, and C was prepared using three extruders to feed a 25 cm wide 3 layer multi-manifold die (obtained under the trade designation “CLOEREN” from Cloeren Inc., Orange Tex.) . The extrusion process was done vertically downward into a nip consisting of a tooling roll (236) and a smooth steel backup roll (234). The extrusion process was configured such that layer A contacted the tooling roll (236) and layer C contacted the backup roll (234) as shown schematically in FIG. 2. The polymer for layer A was provided with a 6.35 cm single screw extruder. The polymer for layer B was provided with a 6.35 cm single screw extruder. The polymer for layer C was provided with a 3.2 cm single screw extruder. Heating zone temperatures for the three extruders is shown in Table 1, below.

TABLE 1

| | 6.35 cm | 6.35 cm | 3.2 cm | |
|---|---|---|---|---|
| Heating | (2.5 inch) | (2.5 inch) | (1.25 inch) | Die, |
| Zones | Layer A, ° C. | Layer B, ° C. | Layer C, ° C. | ° C. |
| Zone 1 | 171 | 190 | 171 | 218 |
| Zone 2 | 177 | 204 | 177 | 218 |
| Zone 3 | 182 | 218 | 182 | 218 |
| Zone 4 | 182 | 218 | N/A | N/A |
| End cap | 182 | 218 | 182 | N/A |
| Neck Tube | 182 | 218 | 182 | N/A |

The rpms of the extruders are listed in Table 2, below.

TABLE 2

| | 6.35 cm | 6.35 cm | 3.2 cm |
|---|---|---|---|
| | (2.5 inch) | (2.5 inch) | (1.25 inch) |
| | Layer A | Layer B | Layer C |
| Extruder rpm | 3.9 | 4 | 16.9 |

Layers A (211) and C (213) were extruded using a low density polyethylene resin (55 melt flow rate; obtained under the trade designation “DOW 959S” from Dow Chemical Company, Midland, Mich.). The basis weights for layers A (211) and C (213) were 81 g/m² and 52 g/m², respectively. Layer B (212) was extruded using polypropylene/polyethylene impact copolymer (35 melt flow rate; obtained under the trade designation “DOW C700 35N” from Dow Chemical Company. The basis weight of layer B (212) was 64 g/m².

The two rolls comprising the nip were water cooled rolls (234, 236) with a nominal 30.5 cm in diameter and 40.6 cm face widths. Nip force was provided by pneumatic cylinders. The smooth steel backup roll (234) temperature set point of 21° C. The tooling roll (236) had male post features (237) cut into the surface of the roll. The male post features were chrome plated. The male features (defined as posts) (237) on the tool surface were flat square topped pyramids with a square base. The top of the posts were 94 micrometers square and the bases were 500 micrometers square. The overall post height was 914 micrometers. The center to center spacing of the posts was 820 micrometers in both the radial and cross roll directions. The tooling roll (236) had a temperature set point of 38° C. The tooling roll (236) and backup roll (234) were directly driven. The nip force between the two nip rolls was 531 Newtons per linear centimeter. The extrudate takeaway line speed was 3.0 m/min.

The polymers for the three layers were extruded from the die (230) directly into the nip (235) between the tooling (236) and backup roll (234). The male features (237) on the tooling roll (236) created indentations (214) in the extrudate. A thin layer of polymer (215) remained between the tooling (236) and backup roll (234). Typically this layer (215) was less than 20 micrometer thick. The extrudate remained on the tooling roll (236) for 180 degrees of wrap to chill and solidify the extrudate into a multi-layer polymeric film. The multi-layer film was then wound into roll form.

The multi-layer polymeric film containing indentations was then converted into a perforated film as follows. A flame perforation system as described in U.S. Pat. No. 7,037,100 (Strobel et. al.), the disclosure of which is incorporated herein by reference, and utilizing the burner design from U.S. Pat. No. 7,635,264 (Strobel et. al.), the disclosure of which is incorporated herein by reference, was used to melt and remove the thin layer (215).

Specific modifications to the equipment and process conditions for this experiment were as follows:
The chill roll (238) was a smooth surface roll without an etched or engraved pattern.
The burner (231) was a 30.5 centimeter (12 inch) six port burner, anti howling design as described in U.S. Pat. No. 7,635,264 (Strobel et. al.), the disclosure of which is incorporated herein by reference, and was obtained from Flynn Burner Corporation, New Rochelle, N.Y.
Unwind Tension: 178 Newton total tension
Winder Tension: 178 Newton total tension
Burner (231) BTU's 5118 BTU/cm/hour
1% excess oxygen
Gap between burner (231) and the film surface: 12 mm
Line Speed: 30 meters/minute
Chill roll (238) cooling water set point: 15.5° C.

The multilayer polymeric film was processed through the apparatus schematically shown in FIG. 2A at the above conditions. The web orientation was such that the side of the film (210) with the thin polymer layer (215) was closest to the burner (231) and opposite of the chill roll (238). The chill roll (238) cooled the main body of the film, keeping the majority of the film below the softening point of the polymer. Heat from the burner flame (239) caused the remaining thin polymer layer (215) to melt thereby creating the perforations (216) in the film. Layers A, B and C were separated from each other and individually wound into separate rolls.

Foreseeable modifications and alterations of this disclosure will be apparent to those skilled in the art without departing from the scope and spirit of this invention. This invention should not be restricted to the embodiments that are set forth in this application for illustrative purposes.

1. A method of making at least two distinct, separate polymeric films, the method comprising:
extruding at least two polymeric layers into a nip to provide a polymeric multilayer film, wherein the nip comprises a first roll having a structured surface that imparts indentations through a first major planar surface of the polymeric multilayer film; and
passing the first major planar surface having the indentations over a chill roll while applying a heat source to a generally opposed second major surface of the polymeric multilayer film, wherein the application of heat from the heat source results in formation of an array of openings extending between the first and second major surfaces of the polymeric multilayer film; and
separating at least the first and second layers of the polymeric multilayer film having the array of openings to provide at least two distinct, separate polymeric films.

2. The method of claim 1, wherein the first layer has a thickness not greater than 125 micrometers.

3. The method of claim 1, wherein the second layer has a thickness not greater than 125 micrometers.

4. The method of claim 1 having at least 30 openings/cm².
